(19) United States
(12) Patent Application Publication
(10) Pub. No.: US 2025/0037040 A1
(43) Pub. Date: Jan. 30, 2025

(54) CRAWLER CONNECT SERVICE FOR AUTOMATED AVAILABILITY DETECTION AND PERSONALIZED NOTIFICATION GENERATION

(71) Applicant: Noteefy Inc, Woodland Hills, CA (US)

(72) Inventors: Dathan Wong, Los Angeles, CA (US); Jake Gordon, Los Angeles, CA (US)

(21) Appl. No.: 18/379,233

(22) Filed: Oct. 12, 2023

Related U.S. Application Data
(60) Provisional application No. 63/528,487, filed on Jul. 24, 2023.

(51) Int. Cl. G06Q 10/02

(52) U.S. Cl. CPC G06Q 10/02

(57) ABSTRACT

A computing platform may receive, from a user device, a search query. The computing platform may identify a golf tee time. The computing platform may identify that the golf tee time is relevant to the search query, and perform a parameter comparison for the golf tee time by: 1) identifying that the golf tee time has a time value later than a predetermined time duration from a current time, 2) identifying that a historical notification indicating the golf tee time has not been sent, and 3) identifying that the golf tee time has existed for more than a minimum duration of time. Based on results of the parameter comparison, the computing platform may activate an availability flag. Based on detecting activation of the availability flag, the computing platform may send, to the user device an availability notification indicating the golf tee time.

### BACKGROUND

Aspects of the disclosure relate to computer hardware and software for availability detection and notification generation. In some instances, venues and/or services may be reserved to guarantee access to such venues/services at a particular time. In some instances, such reservations may occur via a phone call or other non-electronic communication between a potential customer and an employee of the corresponding venue or service. In these instances, however, a number of available reservations may remain unfilled (e.g., due to last minute cancellations, or the like). Similarly, it may be cumbersome and/or inefficient for the employee to manage such reservations over the phone. Accordingly, it may be important to improve the methods by which such reservations are secured. However, it may be difficult to automatically identify availability, and to notify customers accordingly without unduly burdening a customer experience.

### SUMMARY

Aspects of the disclosure provide effective, efficient, scalable, and convenient technical solutions that address and overcome the technical problems associated with automated availability detection and notification generation. In accordance with one or more embodiments of the disclosure, a computing platform comprising at least one processor, a communication interface, and memory storing computer-readable instructions may receive, from a user device, a search query requesting availability information corresponding to preference information. The computing platform may receive, from a plurality of crawler systems, the availability information. The computing platform may aggregate the availability information. The computing platform may identify a subset of the availability information relevant to the search query. The computing platform may perform a parameter comparison for the subset of the availability information, which may include, for all given information included in the subset of the availability information: 1) identifying whether or not the given information has a time value later than a predetermined time duration from a current time, 2) identifying whether or not a historical notification previously indicated the given information, and 3) identifying whether or not the given information has existed for more than a minimum duration of time. Based on detecting that: 1) the given information has a time value that is later than the predetermined time duration, 2) the historical notification did not previously indicate the given information, and 3) the given information has existed for more than the minimum duration of time, the computing platform may activate an availability flag (e.g., by changing the availability flag from false to true). Based on detecting activation of the availability flag from false to true, the computing platform may send, to the user device, an availability notification indicating the given information.

In one or more instances, the availability information may be golf tee time information. In one or more instances, the preference information may include a golf course, a date, a time range, and/or other information.

In one or more examples, each of the plurality of crawler systems may be configured to crawl a tee time availability system at a corresponding golf course. In one or more examples, the computing platform may send one or more commands to each of the plurality of crawler systems directing the corresponding crawler systems to execute the crawl during a specified time period, which may cause each of the plurality of crawler systems to execute the crawl during the corresponding specified time period.

In one or more instances, the specified time period may correspond to an amount of days that tee times, for a corresponding golf course, may be booked in advance. In one or more instances, the specified time period may correspond to a daily time range.

In one or more examples, the one or more commands to each of the plurality of crawler systems directing the corresponding crawler systems to execute the crawl during the specified time period may cause each of the plurality of crawler systems to execute the crawl at a specified frequency. In one or more examples, frequency may be dynamically adjusted using an artificial intelligence (AI) model.

In one or more instances, training the AI model based on historical booking information may include one or more of: season information, location information, longitude information, latitude information, weather information, days of a week, golf course information, or whether a golf course is public or private. Training the AI model may configure the AI model to output, for each of the plurality of crawler systems, one or more of: a frequency at which the crawl executes or a frequency distribution over which the crawl executes, where the frequency distribution may indicate a plurality of frequencies and corresponding time ranges during which the crawl executes according to each of the plurality of frequencies. In one or more instances, the AI model may be further trained, using a dynamic feedback loop, based on the frequency and the given information.

In one or more examples, dynamically adjusting the frequency may cause a first crawler system of the plurality of crawler systems to crawl at multiple different frequencies during a single day. In one or more examples, dynamically adjusting the frequency may cause a first crawler system of the plurality of crawler systems to crawl according to a first frequency distribution during a first day and a second frequency distribution during a second day, where the first day and the second day may occur within a week of each other.

In one or more instances, dynamically adjusting the frequency may cause a first crawler system of the plurality of crawler systems to crawl at a first frequency and a second crawler system of the plurality of crawler systems to crawl at a second frequency. In one or more instances, the computing platform may store previously received availability information, which may have been collected during a most recent previously conducted crawl, where identifying whether or not the given information has existed for more than a minimum duration of time may include: 1) comparing the given information to the previously received availability information, 2) based on identifying that the given information is included in the previously received availability information, identifying that the given information has existed for at least the minimum duration of time, and 3) based on identifying that the given information is not included in the previously received availability information, identifying that the given information has not existed for more than the minimum duration of time. In one or more instances, the availability notification may indicate that at least one tee time is available within a time range specified in the search query.

In one or more examples, the availability notification may include a selectable user interface element corresponding to each tee time range indicated in the availability notification. In one or more examples, based on receiving a user input corresponding to one of the selectable user interface elements, the computing platform may send one or more commands directing a booking system for a golf course of a particular tee time associated with the one of the selectable user interface elements to book the particular tee time, which may cause the booking system for the golf course of the particular tee time associated with the one of the selectable user interface elements to book the particular tee time.

In accordance with one or more additional or alternative embodiments of the disclosure, a computing platform comprising at least one processor, a communication interface, and memory storing computer-readable instructions may receive, from a user device, a search query, requesting golf tee time availability information corresponding to preferences specified in the search query. The computing platform may receive, from a plurality of crawler systems, at least one golf tee time. The computing platform may identify that the at least one golf tee time is relevant to the search query. The computing platform may perform a parameter comparison for the at least one golf tee time by: 1) identifying that the at least one golf tee time has a time value later than a predetermined time duration from a current time, 2) identifying that a historical notification indicating the at least one golf tee time has not been sent, and 3) identifying that the at least one golf tee time has existed for more than a minimum duration of time. Based on results of the parameter comparison, the computing platform may activate an availability flag (e.g., by changing the availability flag from false to true). Based on detecting activation of the availability flag from false to true, the computing platform may send, to the user device an availability notification indicating the at least one golf tee time.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1C depict an illustrative computing environment for automated availability detection and notification generation in accordance with one or more example embodiments;

FIGS. 2A-2D depict an illustrative event sequence for automated availability detection and notification generation in accordance with one or more example embodiments;

FIG. 3 depicts an illustrative method for automated availability detection and notification generation in accordance with one or more example embodiments; and

FIG. 4 depicts an illustrative graphical user interface for automated availability detection and notification generation in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction of the concepts described in further detail below, systems and methods for improved availability detection and notification generation are described herein. For example, in certain instances (e.g., at times and/or venues of high demand and/or otherwise), it may be difficult to identify availability that complies with a set of user preferences. Once such availability is identified, it may be important to generate and provide notifications of the availability in the most efficient, effective, and consumer friendly way possible.

For example, users may wish to book golf tee times or other reservations the moment that a time or reservation (e.g., a tee time), which matches their search preferences, becomes available. To do so, the user may access a website, and input their search preferences (e.g., time range, dates, where they want to play (or otherwise engage in an event/reservation), how many players (or otherwise a number of individuals to be included in the reservation), and/or other information. When the system finds a tee time, reservation, and/or other availability matching the search preferences, an alert may be generated and sent to the user for booking

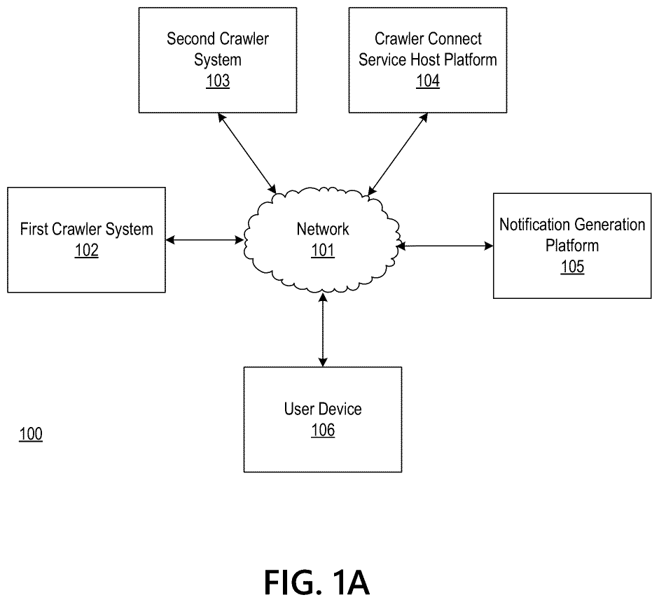

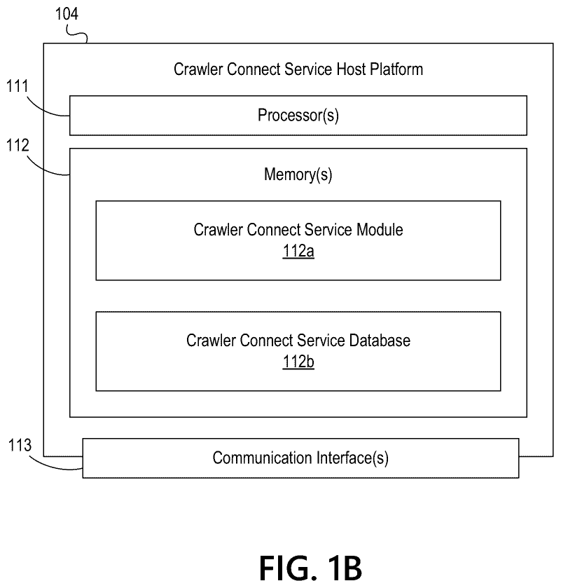

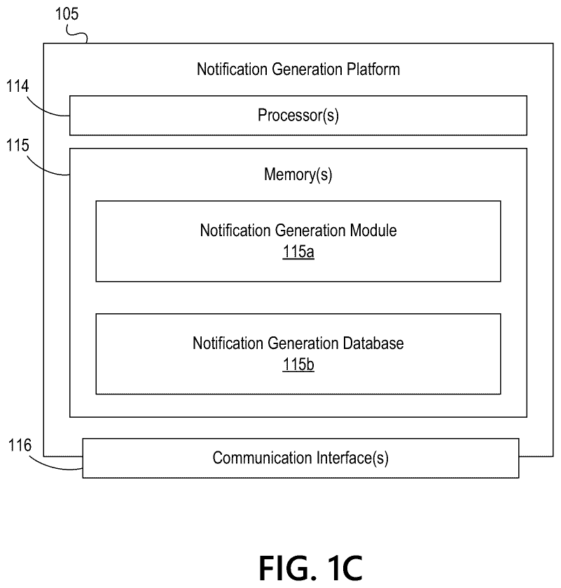

FIGS. 1A-1C depict an illustrative computing environment for automated availability detection and notification generation in accordance with one or more example embodiments. Referring to FIG. 1A, computing environment 100 may include one or more computer systems. For example, computing environment 100 may include network 101, one or more crawler systems (e.g., first crawler system 102, second crawler system 103, or the like), crawler connect service host platform 104, notification generation platform 105, and user device 106.

First crawler system 102 may be a computer system that includes one or more computing devices (servers, or the like) and/or other computer components (e.g., processors, memories, communication interfaces, or the like) that may be used to crawl for information. For example, the first crawler system 102 may be associated with a particular enterprise (e.g., a golf course, restaurant, airport, or the like), and may be configured to crawl an enterprise system (associated with the enterprise) for availability (e.g., tee times, reservations, flights, availabilities, or the like).

Second crawler system 103 may be a computer system that includes one or more computing devices (servers, or the like) and/or other computer components (e.g., processors, memories, communication interfaces, or the like) that may be used to crawl for information. For example, the second crawler system 103 may be associated with a different enterprise (e.g., a different golf course, restaurant, airport, or the like), and may be configured to crawl an enterprise system (associated with the different enterprise) for availability (e.g., tee times, reservations, flights, availabilities, or the like). Although two crawler systems are described, this is for illustrative purposes only, and any number of such crawler systems may be implemented without departing from the scope of the disclosure.

Crawler connect service host platform 104 may be a computer system that includes one or more computing devices (servers, or the like) and/or other computer components (e.g., processors, memories, communication interfaces, or the like) that may be used to compile and/or otherwise aggregate the information collected by various crawler systems (e.g., first crawler system 102, second crawler system 103, or the like). Furthermore, the crawler connect service host platform 104 may be configured to analyze this information and set, update, and/or otherwise adjust an availability flag accordingly, as is described further below. In some instances, one or more crawler systems (e.g., first crawler system 102, second crawler system 103, or the like) may be integrated into the crawler connect service host platform 104. In other instances, one or more of these systems may be distinct from the crawler connect service host platform 104.

Notification generation platform 105 may be a computer system that includes one or more computing devices (servers, or the like) and/or other computer components (e.g., processors, memories, communication interfaces, or the like) that may be used to generate availability notifications. For example, the notification generation platform 105 may be configured to generate and send availability notifications based on a status of the availability flag (e.g., set by the crawler connect service host platform 104). In some instances, the notification generation platform 105 may generate notifications indicating availability of tee times, dining reservations, flights, and/or other reservations/availabilities. In some instances, the notification generation platform 105 may be integrated into the crawler connect service host platform 104. In other instances, the notification generation platform 105 may be distinct from the crawler connect service host platform 104.

User device 106 may be and/or otherwise include a laptop computer, desktop computer, mobile device, tablet, smartphone, and/or other device that may be used by an individual (such as an individual looking to make a booking such as a tee time, dining reservation, flight, and/or other reservation/booking). In some instances, user device 106 may be configured to display one or more user interfaces (e.g., availability notification interfaces, or the like). Although a single user device 106 is shown, any number of user devices may be deployed in the systems/methods described below without departing from the scope of the disclosure.

Computing environment 100 also may include one or more networks, which may interconnect first crawler system 102, second crawler system 103, crawler connect service host platform 104, notification generation platform 105, user device 106, or the like. For example, computing environment 100 may include a network 101 (which may interconnect, e.g., first crawler system 102, second crawler system 103, crawler connect service host platform 104, notification generation platform 105, user device 106, or the like).

In one or more arrangements, first crawler system 102, second crawler system 103, crawler connect service host platform 104, notification generation platform 105, and user device 106 may be any type of computing device capable of sending and/or receiving requests and processing the requests accordingly. For example, first crawler system 102, second crawler system 103, crawler connect service host platform 104, notification generation platform 105, user device 106, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of first crawler system 102, second crawler system 103, crawler connect service host platform 104, notification generation platform 105, and/or user device 106 may, in some instances, be special-purpose computing devices configured to perform specific functions.

Referring to FIG. 1B, crawler connect service host platform 104 may include one or more processors 111, memory(s) 112, and communication interface(s) 113. A data bus may interconnect processor 111, memory 112, and communication interface 113. Communication interface 113 may be a network interface configured to support communication between crawler connect service host platform 104 and one or more networks (e.g., network 101, or the like). Memory 112 may include one or more program modules having instructions that when executed by processor 111 cause crawler connect service host platform 104 to perform one or more functions described herein and/or one or more databases that may store and/or otherwise maintain information which may be used by such program modules and/or processor 111. In some instances, the one or more program modules and/or databases may be stored by and/or maintained in different memory units of crawler connect service host platform 104 and/or by different computing devices that may form and/or otherwise make up crawler connect service host platform 104. For example, memory 112 may have, host, store, and/or include crawler connect service module 112a and crawler connect service database 112b.

Crawler connect service module 112a may have instructions that direct and/or cause crawler connect service host platform 104 to provide improved availability detection and selection techniques, as discussed in greater detail below. Crawler connect service database 112b may store information used by crawler connect service module 112a and/or crawler connect service host platform 104 in application of advanced techniques to provide improved availability detection and selection techniques, and/or in performing other functions.

Referring to FIG. 1C, notification generation platform 105 may include one or more processors 114, memory(s) 115, and communication interface(s) 116. A data bus may interconnect processor 114, memory 115, and communication interface 116. Communication interface 116 may be a network interface configured to support communication between notification generation platform 105 and one or more networks (e.g., network 101, or the like). Memory 115 may include one or more program modules having instructions that when executed by processor 114 cause notification generation platform 105 to perform one or more functions described herein and/or one or more databases that may store and/or otherwise maintain information which may be used by such program modules and/or processor 114. In some instances, the one or more program modules and/or databases may be stored by and/or maintained in different memory units of notification generation platform 105 and/or by different computing devices that may form and/or otherwise make up notification generation platform 105. For example, memory 115 may have, host, store, and/or include notification generation module 115a and notification generation database 115b.

Notification generation module 115a may have instructions that direct and/or cause notification generation platform 105 to provide improved notification generation techniques, as discussed in greater detail below. Notification generation database 115b may store information used by notification generation module 115a and/or notification generation platform 105 in application of advanced techniques to provide improved notification generation, and/or in performing other functions. As described above, in some instances, the notification generation platform 105 may be distinct from the crawler connect service host platform 104, and in other instances, may be integrated into the crawler connect service host platform 104.

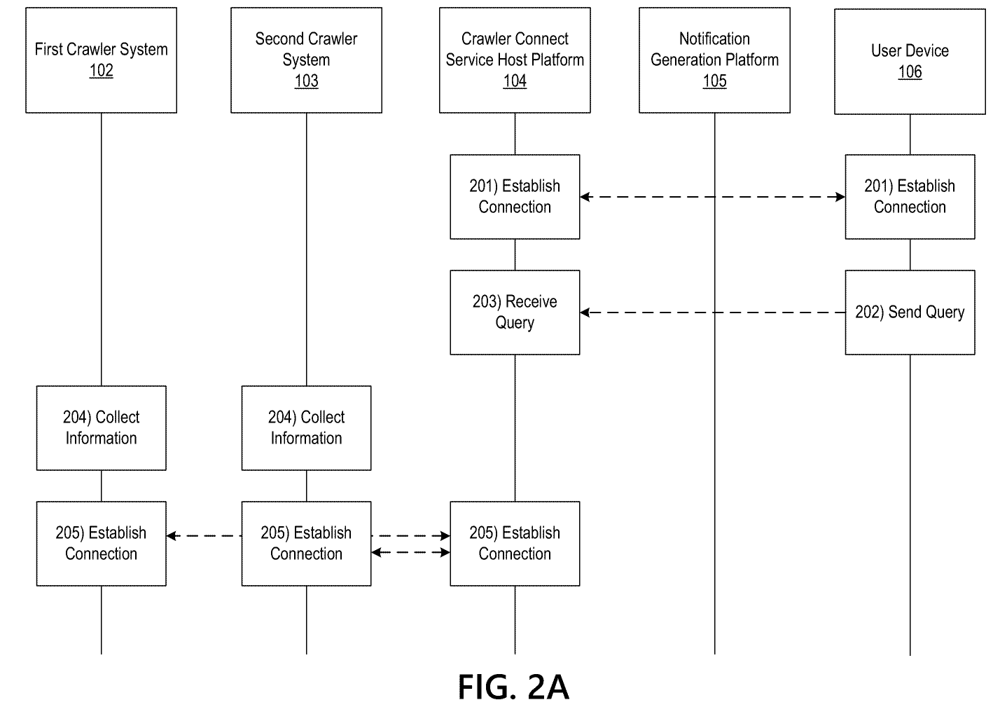

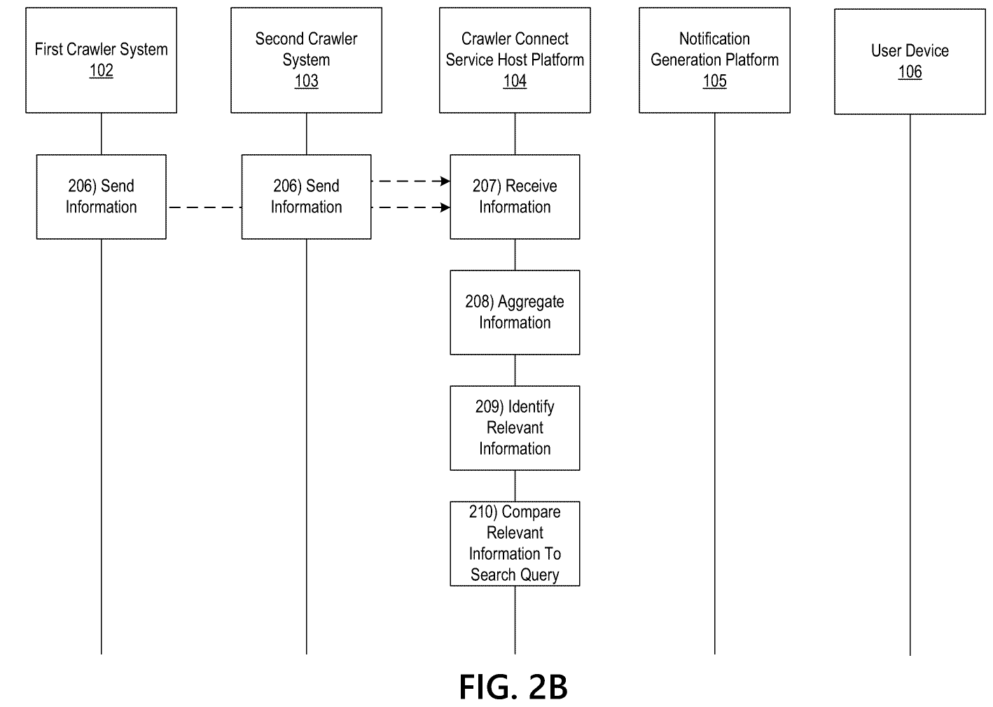

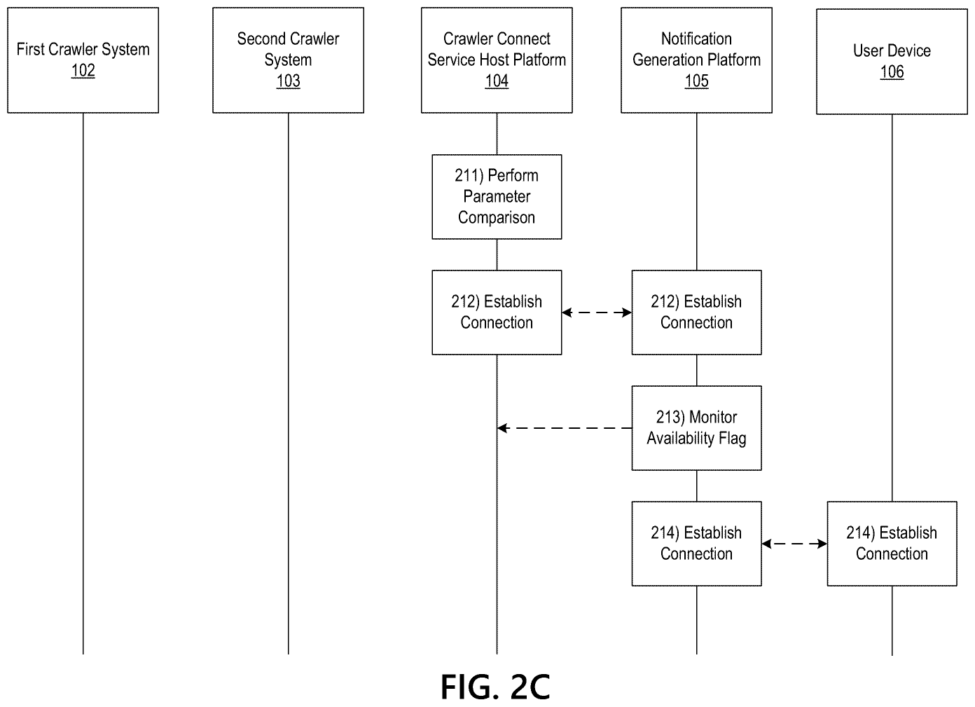

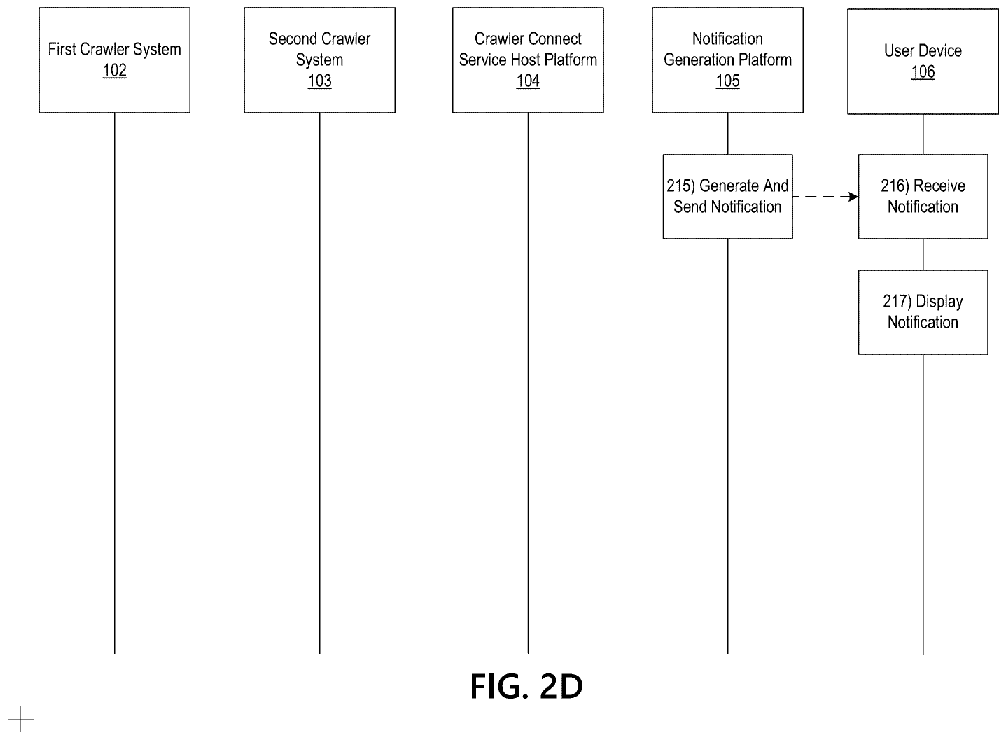

FIGS. 2A-2D depict an illustrative event sequence for automated availability detection and notification generation in accordance with one or more example embodiments. Referring to FIG. 2A, at step 201, the user device 106 may establish a connection with the crawler connect service host platform 104. For example, the user device 106 may establish a first wireless data connection with the crawler connect service host platform 104 to link the user device 106 to the crawler connect service host platform 104 (e.g., in preparation for sending search queries). In some instances, the user device 106 may identify whether a connection is already established with the crawler connect service host platform 104. If a connection is already established with the crawler connect service host platform 104, the user device 106 might not re-establish the connection. Otherwise, if a connection is not yet established with the crawler connect service host platform 104, the user device 106 may establish the first wireless data connection as described herein.

At step 202, the user device 106 may send a query to the crawler connect service host platform 104. For example, the user device 106 may display a graphical user interface prompting a user to input their desired preferences (e.g., date, time, venue, number of people, or the like). In the context of tee times, the user device 106 may prompt the user to input a number of players, a course, a time range, a price range, and/or other information. In some instances, the user device 106 may send the query to the crawler connect service host platform 104 while the first wireless data connection is established.

At step 203, the crawler connect service host platform 104 may receive the query sent at step 202. For example, the crawler connect service host platform 104 may receive the query while the first wireless data connection is established.

At step 204, the first crawler system 102, second crawler system 103, and/or other crawler systems may collect information. For example, the first crawler system 102, second crawler system 103 and/or other crawler systems may crawl availability/reservation systems for given enterprises in an industry affiliated with the search query. For example, in the context of golf tee times, the crawler systems may crawl tee time availability systems for a number of golf courses. In these instances, each crawler system may be assigned to a particular venue (e.g., a particular golf course, or the like). For example, the first crawler system 102 may be configured to crawl availability information for a first venue (e.g., a first golf course), whereas the second crawler system 103 may be configured to crawl availability information for a second venue (e.g., a second golf course). By operating in this way, the crawler systems are able to run independently and might not affect each other when grabbing tee time (or other availability) information.

In some instances, the first crawler system 102 and/or second crawler system 103 may execute the crawls (e.g., information collection) based on or in response to receiving instructions from the crawler connect service host platform 104. In some instances, these instructions may specify a particular time period during which the crawling should occur (e.g., between 4:30 am and 2 am, or the like). By doing so, the crawler connect service host platform 104 may avoid crawling at times when users are unlikely to be searching for availability (e.g., tee time availability, or the like). Additionally or alternatively, the instructions may specify particular days during which the crawling should occur, which may, e.g., be based on how far in advance a particular booking, reservation, tee time, or the like may be made. For example, the instructions may direct the first crawler system 102 to begin crawling seven days in advance of a tee time, where tee times may only be booked a week in advance. This may conserve processing power by only crawling for data/information that may be used for a valid booking, and may similarly reduce an amount of data to be provided to and processed by the logic (which is described further below).

Additionally or alternatively, the instructions may specify a frequency at which the crawling should occur (e.g., every three minutes, six minutes, or the like), and/or a frequency distribution (e.g., crawl at a first frequency during a first time range, a second frequency during a second time range, or the like). For example, a frequency distribution may specify different frequencies to occur during a single day (e.g., night vs. day, most popular booking times, or the like), on different days (e.g., weekday vs. weekend, or the like), and/or otherwise. In some instances, different frequencies may be identified for different venues (e.g., golf courses, or the like), and thus the different crawler systems may be instructed accordingly. In some instances, the crawler connect service host platform 104 may identify and/or dynamically adjust these frequencies and/or frequency distributions using an artificial intelligence (AI) model.

For example, the crawler connect service host platform 104 may train a machine learning model (e.g., a crawl frequency selection model). For example, the crawler connect service host platform 104 may train the crawl frequency selection model to identify a frequency (and/or frequency distribution) at which crawling should occur. For example, the crawler connect service host platform 104 may receive historical booking information such as season information, location information, longitude information, latitude information, weather information, date/time/day information, golf course information (e.g., name, whether the course is public or private, course usage/traffic, or the like), frequency information, historical bookings, and/or other information. The crawler connect service host platform 104 may input the historical booking information into the crawl frequency selection model to train the crawl frequency selection model to establish stored correlations between such historical booking information and the frequencies/frequency distributes of the associated crawls. In doing so, the crawler connect service host platform 104 may train the crawl frequency selection model to identify, based on a given booking scenario, a frequency and/or frequency distribution at which the crawl should be performed.

In some instances, in training the crawl frequency selection model, the crawler connect service host platform 104 may train a supervised learning model (e.g., decision tree, bagging, boosting, random forest, neural network, linear regression, artificial neural network, support vector machine, deep reinforcement learning model, and/or other supervised learning model), unsupervised learning model (e.g., classification, clustering, anomaly detection, feature engineering, feature learning, and/or other unsupervised learning models), and/or other model.

Once trained, the crawl frequency selection model may be used by the crawler connect service host platform 104 to identify a frequency and/or frequency distribution with which to instruct the first crawler system 102, second crawler system 103, and/or other crawler systems. For example, the crawler connect service host platform 104 may identify a frequency and/or frequency distribution that may be most optimal (e.g., in terms of balancing processing resources with providing accurate availability, or the like). To do so, the crawler connect service host platform 104 may input information from the query and/or other current conditions into the crawl frequency selection model, which may, e.g., output a corresponding frequency and/or frequency distribution.

Once the frequency and/or frequency distribution has been output, the crawler connect service host platform 104 may update the crawl frequency selection model based on the selected frequency/frequency distribution, any input information, tee time selection information (e.g., in some instances the update may occur once a tee time, booking, and/or other reservation has been selected by a user corresponding to the query), and/or other information. In doing so, the crawler connect service host platform 104 may continue to refine the crawl frequency selection model using a dynamic feedback loop, which may, e.g., increase the accuracy and effectiveness of the model in selecting frequencies and/or frequency distributions associated with the crawls.

In some instances, the crawler connect service host platform 104 may continuously refine the crawl frequency selection model. In some instances, the crawler connect service host platform 104 may maintain an accuracy threshold for the crawl frequency selection model, and may pause refinement (through the dynamic feedback loops) of the model if the corresponding accuracy is identified as greater than the corresponding accuracy threshold. Similarly, if the accuracy fails to be equal or less than the given accuracy threshold, the crawler connect service host platform 104 may resume refinement of the model through the corresponding dynamic feedback loop.

Returning to the crawls themselves, once the instructions have been received from the crawler connect service host platform 104 indicating where, when, and at what frequency the crawls should occur, the first crawler system 102, second crawler system 103, and/or other crawler systems may execute the crawls accordingly. For example, the crawler systems may collect information (e.g., availability of tee times, bookings, reservations, or the like) at a specified frequency from a specified venue (e.g., golf course, or the like).

At step 205, the first crawler system 102 and/or the second crawler system 103 may establish connections with the crawler connect service host platform 104. For example, the first crawler system 102 and/or the second crawler system 103 may establish second and/or third wireless data connections with the crawler connect service host platform 104 to link the first crawler system 102 and/or the second crawler system 103 to the crawler connect service host platform 104 (e.g., in preparation for providing the collected information). In some instances, the first crawler system 102 and/or the second crawler system 103 may identify whether a connection is already established with the crawler connect service host platform 104. If a connection is already established with the crawler connect service host platform 104, the first crawler system 102 and/or the second crawler system 103 might not re-establish the second and/or third wireless data connections. If a connection is not yet established with the crawler connect service host platform 104, the first crawler system 102 and/or the second crawler system 103 may establish the second and/or third wireless data connections accordingly.

Referring to FIG. 2B, at step 206, after collecting the information, the crawler systems may transfer the information to the crawler connect service host platform 104 (e.g., for the purpose of initiating logic to identify whether or not a user's desired availability (e.g., for a tee time, or the like) has been found, and whether or not to alert the user accordingly. For example, the first crawler system 102 and/or the second crawler system 103 may send the information while the second and/or third wireless data connections are established accordingly.

At step 207, the crawler connect service host platform 104 may receive the information sent at step 206. For example, the crawler connect service host platform 104 may receive the information via the communication interface 113 and while the second and/or third wireless data connections are established.

At step 208, the crawler connect service host platform 104 may aggregate any collected information and corresponding search queries. For example, the crawler connect service host platform 104 may have received availability information from one or more crawler systems, each specific to a particular venue, and may aggregate or otherwise assemble the information into a central information set. In some instances, the crawler connect service host platform 104 might not have received any information from the crawler systems. For example, because the web crawler systems are scraping the web for information, the requests may sometimes be blocked and/or otherwise produce no results. If no information is received, the crawler connect service host platform 104 may stop processing (and might not proceed to the remaining logic) so that it does not produce inaccurate conclusions based on faulty or missing information.

For availability information that was collected, the crawler connect service host platform 104 may identify any corresponding active searches. For example, if availability information for a first golf course (or other venue/enterprise) is received, the crawler connect service host platform 104 may identify any active searches (such as the search query received at step 203), which may be searching for availability (e.g., tee times) for that first golf course (or availability for other venues/enterprises). In these instances, an active search may be a search that has not been cancelled or otherwise processed, and is also requesting availability at a time in the future (e.g., rather than retroactively). For illustrative purposes, it may be assumed that the search query received at step 203 is an active search.

At step 209, the crawler connect service host platform 104 may begin looping through the active searches. For example, with regard to the search query received at step 203, the crawler connect service host platform 104 may identify whether or not any of the availability information (e.g., tee times or other reservations) from the crawler systems are relevant to the search query (e.g., does the availability information match what was requested in terms of date and golf course, or whatever else was requested). More specifically, the crawler connect service host platform 104 may identify whether or not the availability information indicates a tee time for the same course, date, and/or other preference information specified by the user in the search query. For example, in some instances, the crawler systems may inadvertently miss availability information for certain dates, which may lead to a false conclusion that there is no availability on these days. If the crawler connect service host platform 104 identifies that no availability information is relevant, it might not proceed, and may instead await further information from the crawler systems. Otherwise, if the crawler connect service host platform 104 identifies that availability information is relevant, it may proceed to step 210.

At step 210, the crawler connect service host platform 104 may identify whether or not any of the availability information (e.g., tee times or other reservations) from the crawler systems match preference information (e.g., time range, course/venue, number of players/participants, or the like) specified in the search query. If there is no availability (e.g., tee times, reservations, bookings, or the like) that matches the preference information specified in the search query, the crawler connect service host platform 104 may set an availability flag on the search query to false. In doing so, the crawler connect service host platform 104 may indicate that there is no availability (e.g., tee times, bookings, reservations, or the like) matching the query request. If the crawler connect service host platform 104 does identify availability matching the query request, it may proceed to step 211.

Referring to FIG. 2C, at step 211, the crawler connect service host platform 104 may check further parameters corresponding to the availability information to identify how the availability flag should be set. For example, the crawler connect service host platform 104 may identify whether or not any identified tee times or other reservations are within a predetermined time window of a current time (e.g., fifteen minutes, or the like). In some instances, the predetermined time window may be dynamically configured on a venue by venue basis (e.g., a course by course basis, or the like). If the crawler connect service host platform 104 identifies that all identified tee times, reservations, or the like are within the predetermined time window, it may set the availability flag to false. If the crawler connect service host platform 104 identifies that at least one identified tee time, reservation, or the like is outside of the predetermined time window, the crawler connect service host platform 104 may perform further parameter analysis with regard to the corresponding tee time, reservation, or the like. In doing so, the crawler connect service host platform 104 may ensure that the tee times or other reservations are at times where the user may reasonably attend them (e.g., it may be unrealistic for a user to attend a tee time that is occurring five minutes from a current time, as they may need to commute to the golf course, or the like). In some instances, the user's location may be further considered by the crawler connect service host platform 104. For example, in some instances, if the at least one identified tee time, reservation, or the like is outside of the predetermined time window, the crawler connect service host platform 104 may further consider a likelihood or ability of the user to arrive in time based on their location. In these instances, if it is reasonable for the user to attend the tee time or other reservation based on their location, the crawler connect service host platform 104 may perform further parameter analysis as described further below. Otherwise, if it is not reasonable for the user to attend the tee time or other reservation based on their location, the crawler connect service host platform 104 may set the availability flag to false (despite the tee time or other reservation being outside of the predetermined time window).

As further analysis, the crawler connect service host platform 104 may identify whether or not the at least one identified tee time, reservation, or the like is different than the last tee time, reservation, or the like of which the user was previously notified. If the crawler connect service host platform 104 identifies that the at least one identified tee time, reservation, or the like is not different, the crawler connect service host platform 104 may leave the availability flag set to true. For example, the crawler connect service host platform 104 might not flip the availability flag from true to false because there is still a tee time, reservation, or the like that matches the search query. Rather, the crawler connect service host platform 104 may set the availability flag to false (e.g., flip the availability flag from true to false) when there are no tee times, reservations, or the like at all that match the preferences of the search query. In doing so, the crawler connect service host platform 104 may limit excessive notifications from being triggered and sent to the user (e.g., by not constantly notifying about the same tee times, reservations, or the like). In contrast, if the crawler connect service host platform 104 identifies that at least one identified tee time, reservation, or the like is different, the crawler connect service host platform 104 may perform further parameter analysis with regard to the corresponding tee time, reservation, or the like.

For example, the crawler connect service host platform 104 may identify whether or not the at least one identified tee time, reservation, or the like has existed for at least a threshold period of time (e.g., thirty minutes, or the like). This threshold period of time may be similarly configurable on a course by course (e.g., venue by venue, or the like) basis. For example, if the crawler systems identify tee times, reservations, or the like that have existed for less than the threshold period of time, there might not be a realistic chance for the user to make or otherwise secure the corresponding tee time, reservation, or the like. As an example, employees at a golf course or other venue may be quickly moving tee times, reservations, or the like around, and these tee times may only be available for a short period of time before disappearing. Accordingly, the crawler connect service host platform 104 may avoid notifying the user of these tee times, reservations, or the like to prevent excessive notifications from being sent to the user.

In some instances, to identify whether or not the at least one identified tee time, reservation, or the like has existed for at least the threshold period of time, the crawler connect service host platform 104 may store a most recent set of information collected by the most recent set of crawls. The crawler connect service host platform 104 may then compare the newly identified tee time, reservation, or the like against this stored information to identify whether or not it has existed for at least the threshold amount of time. For example, if the crawlers run every thirty minutes, and the threshold period of time is thirty minutes, the crawler connect service host platform 104 may identify that a given tee time, reservation, or the like has existed for at least the threshold period of time if it is present in the information received from the most recent crawl. In these instances, if the crawler connect service host platform 104 identifies that the tee time, reservation, or the like is present in the information of the previous crawl, the crawler connect service host platform 104 may confirm that it has existed for at least the threshold period of time. In contrast, if the crawler connect service host platform 104 is unable to identify the tee time, reservation, or the like in the information of the previous crawl, the crawler connect service host platform 104 may confirm that it has existed for less than the threshold period of time. This may save a considerable amount of time when compared to waiting a duration corresponding to the threshold period of time prior to sending the identified tee time, reservation, or the like to a user (e.g., waiting until the results of a subsequent crawl come in and comparing accordingly).

If the crawler connect service host platform 104 identifies that the at least one identified tee time, reservation, or the like has not existed for at least the threshold period of time, it may set the availability flag to false. Otherwise, if the crawler connect service host platform 104 identifies that the at least one identified tee time, reservation, or the like has existed for at least the threshold period of time, and the other criteria described above are satisfied, the crawler connect service host platform 104 may set the availability flag to true (or, in instances where the availability flag is already set to true, the crawler connect service host platform 104 may leave the availability flag set to true).

Although several parameter comparisons are described at step 211, other comparisons/analysis may be performed without departing from the scope of the disclosure.

At step 212, the notification generation platform 105 may establish a connection with the crawler connect service host platform 104. For example, the notification generation platform 105 may establish a fourth wireless data connection with the crawler connect service host platform 104 to link the notification generation platform 105 with the crawler connect service host platform 104 (e.g., in preparation for monitoring the availability flag). In some instances, the notification generation platform 105 may identify whether or not a connection is already established with the crawler connect service host platform 104. If a connection is already established with the crawler connect service host platform 104, the notification generation platform 105 might not re-establish the connection. Otherwise, if a connection is not yet established with the crawler connect service host platform 104, the notification generation platform 105 may establish the fourth wireless data connection as described herein.

At step 213, the crawler connect service host platform 104 and/or notification generation platform 105 may monitor the availability flag to detect whether or not the availability flag was flipped from false to true (e.g., based on the parameter comparison performed at step 212). If the crawler connect service host platform 104 and/or notification generation platform 105 identifies that the availability flag was flipped from false to true, the crawler connect service host platform 104 and/or notification generation platform 105 may proceed to step 214. Otherwise, if the crawler connect service host platform 104 and/or notification generation platform 105 identifies that the availability flag was not flipped from false to true (e.g., remained at true, flipped from true to false, or remained at false), event sequence may return to step 204, and the crawler connect service host platform 104 may await additional availability information may be collected for analysis. For example, if the availability flag remains true, there may still be a tee time and/or other reservation available that matches the search query, so an additional notification should not be sent (e.g., to minimize notifications sent to the user). For example, at any given time, if the availability flag remains true, if the user received a notification including a link to available tee times, reservations, or the like, they will already have observed this availability. Rather, by operating in this way, the crawler connect service host platform 104 and/or notification generation platform 105 may proceed to step 214 only where a time slot was not available, but now is available.

As a particular example, the search query may request availability from 9 AM-10 AM, and there may be times available at 9 AM and 9:30 AM. In this instance, a notification may be generated (as described below with regard to step 214). However, if the 9 AM time disappears (i.e., is reserved or otherwise booked), a new notification for the 9:30 AM time might not be generated (e.g., because a notification has already been sent indicating this availability). In contrast, if the 9:30 AM time disappears as well, and then ten minutes later a 9:15 AM time shows up, the crawler connect service host platform 104 may proceed to step 214 to generate a new notification (e.g., to indicate a transition from no availability to some availability). On the other hand, if a notification is generated to indicate availability between 9 AM-10 AM (based on the available 9 AM and 9:30 AM tee times), and a 9:45 AM tee time becomes available, a new notification might not be generated and sent, because a notification indicating general availability between 9 AM-10 AM was already provided. This may avoid overburdening customers with notifications, while still keep them up to date on availability based on their search. In some instances, the notification generation platform 105 may monitor the availability flag while the fourth wireless data connection is established.

At step 214, the notification generation platform 105 may establish a connection with the user device 106. For example, the notification generation platform 105 may establish a fifth wireless data connection with the user device 106 to link the notification generation platform 105 to the user device 106 (e.g., in preparation for sending availability notifications). In some instances, the notification generation platform 105 may identify whether or not a connection is already established with the user device 106. If a connection is already established with the user device 106, the notification generation platform 105 might not re-establish the connection. If a connection is not yet established with the user device 106, the notification generation platform 105 may establish the fifth wireless data connection as described herein.

Referring to FIG. 2D, at step 215, the notification generation platform 105 may generate availability notifications based on the detection (at step 213) that the availability flag has flipped from false to true. In some instances, the notification generation platform 105 may generate multiple availability notifications for responding to the search query (e.g., for different courses, venues, courses/venues under common ownership, or the like). In some instances, the notification generation platform 105 may generate the availability notifications in response to the search query and/or other queries. Once generated, the notification generation platform 105 may gather all of the unsent notifications (e.g., at a predetermined interval such as thirty seconds, or the like), and bundle them to be sent to the appropriate users. By bundling these notifications accordingly (e.g., into common physical emails, texts, and/or other message formats), additional costs of sending separate notifications may be avoided.

For example, the notification generation platform 105 may bundle the availability notifications based on original uniform resource locators (URLs) corresponding to the search query. For example, the original URL may correspond to a main consumer application of the notification generation platform 105 (e.g., http://exampleapplicationservice.app) or a specific partner application of the notification generation platform 105 (e.g., http://venue#1.exampleapplicationservice.app). The notification generation platform 105 may bundle the availability notifications based on these origin URLs (e.g., rather than the names of the golf courses, venues, restaurant, or the like) because one site may have multiple course, restaurants, venues, or the like available for selection, and each site may have a corresponding theme template. For example, the main consumer application may have a first theme template, which may be different than a second theme template for a first golf course associated with a specific partner application, which may in turn be different than a third theme template for a plurality of courses owned by a common entity corresponding to a different specific partner application, or the like. Accordingly, by bundling the availability notifications based on the original URLs, the notification generation platform 105 may avoid branding conflicts among the notifications (e.g., tee times for a first course being displayed alongside a logo, color scheme, and/or other branding associated with a second, non-affiliated, course, or the like).

After generating the availability notification(s), the notification generation platform 105 may send the availability notification(s) for display at the user device 106 accordingly. In some instances, the notification generation platform 105 may send the availability notification(s) to the user device 106 while the fifth wireless data connection is established. In some instances, the notification generation platform 105 may also send one or more commands directing the user device 106 to display the availability notification(s).

At step 216, the user device 106 may receive the availability notification(s) sent at step 215. For example, the user device 106 may receive the availability notification(s) while the fifth wireless data connection is established. In some instances, the user device 106 may also receive the one or more commands directing the user device 106 to display the availability notification(s).

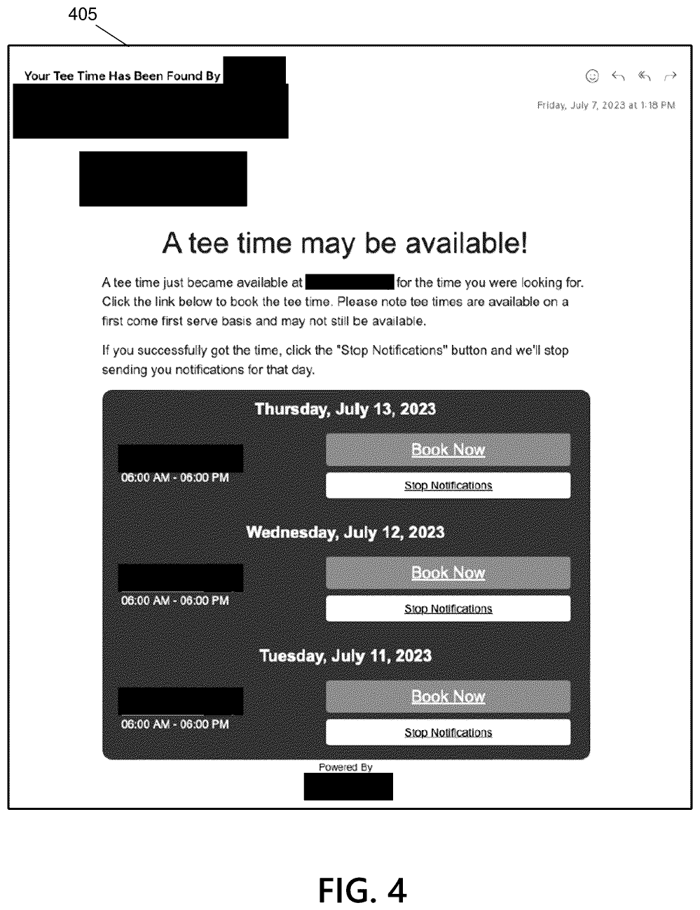

At step 217, based on or in response to the one or more commands directing the user device 106 to display the availability notification(s), the user device 106 may display the availability notification(s). For example, the user device 106 may display a graphical user interface similar to graphical user interface 405, which is illustrated in FIG. 4. For example, graphical user interface 405 may include multiple selectable user interface elements (e.g., corresponding to the various tee time or other reservation windows). In these instances, if user input is received corresponding to selection of one of these user interface elements, a message, notification, signal, and/or other communication may be sent to the crawler connect service host platform 104, which may e.g., cause the crawler connect service host platform 104 to send commands to a corresponding booking system of the corresponding venue (e.g., the corresponding golf course, or the like) directing the booking system to book a tee time corresponding to the user interface element (which may, e.g., cause the booking system to book the tee time accordingly).

Although a number of the above described steps are described as being performed by the crawler connect service host platform 104 and/or the notification generation platform 105, in some instances, these two platforms may be integrated into a common computing platform, and thus these steps may be performed by the common computing platform. Furthermore, although these steps are described primarily in the context of golf tee times, they may be applied to identify availability and generate/send notifications accordingly in any number of alternative contexts (e.g., dining or other reservations, flight or other bookings, and/or any other reservation/booking contexts) without departing from the scope of the disclosure.

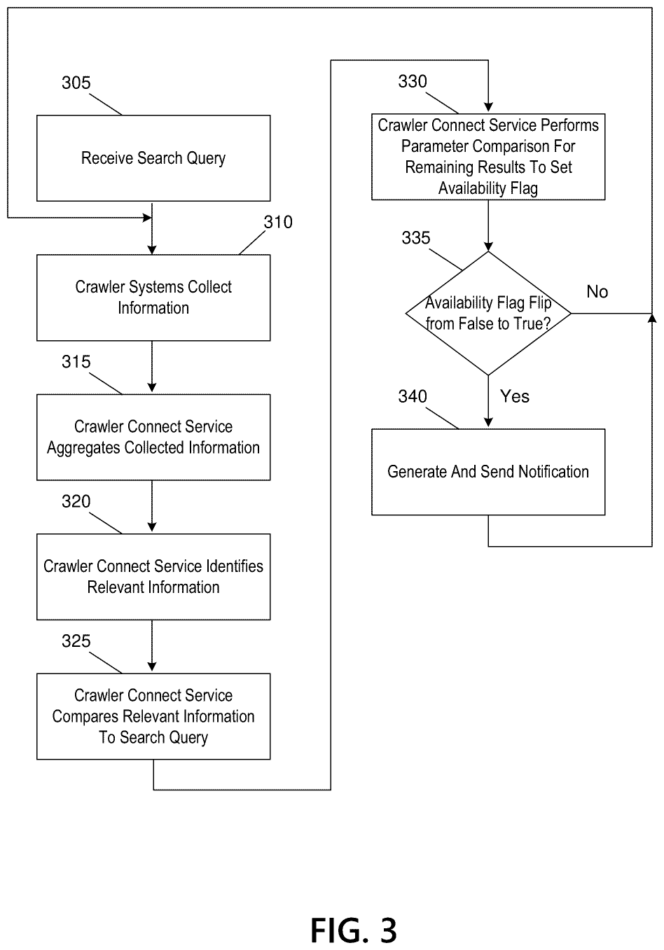

FIG. 3 depicts an illustrative method for automated availability detection and notification generation in accordance with one or more example embodiments. At step 305, a computing platform (e.g., the crawler connect service host platform 104) having at least one processor, a communication interface, and memory may receive a search query. For example, the crawler connect service host platform 104 may receive a query from the user device 106. In these instances, the user device 106 may display a graphical user interface prompting a user to input their desired preferences (e.g., date, time, venue, number of people, or the like). For example, in the context of tee times, the user device 106 may prompt the user to input a number of players, a course, a time range, a price range, and/or other information. The user device 106 may then send this preference information to the crawler connect service host platform 104.

At step 310, the crawler systems (e.g., first crawler system 102, second crawler system 103, or the like) may crawl availability/reservation systems for given enterprises in an industry affiliated with the search query. For example, in the context of golf tee times, the crawler systems may crawl tee time availability systems for a number of golf courses. In these instances, each crawler system may be assigned to a particular venue (e.g., a particular golf course, or the like). For example, the first crawler system 102 may be configured to crawl availability information for a first venue (e.g., a first golf course), whereas the second crawler system 103 may be configured to crawl availability information for a second venue (e.g., a second golf course).

At step 315, the crawler connect service host platform 104 may aggregate any collected information and corresponding search queries. For example, the crawler connect service host platform 104 may have received availability information from one or more crawler systems, each specific to a particular venue, and may aggregate or otherwise assemble the information into a central information set. In some instances, the crawler connect service host platform 104 might not have received any information from the crawler systems. For example, because the web crawler systems are scraping the web for information, the requests may sometimes be blocked and/or otherwise produce no results. If no information is received, the crawler connect service host platform 104 may stop processing (and might not proceed to the remaining logic) so that it does not produce inaccurate conclusions based on faulty or missing information.

For availability information that was collected, the crawler connect service host platform 104 may identify any corresponding active searches. For example, if availability information for a first golf course (or other venue/enterprise) is received, the crawler connect service host platform 104 may identify any active searches (such as the search query received at step 305), which may be searching for availability (e.g., tee times) for that first golf course (or availability for other venues/enterprises). In these instances, an active search may be a search that has not been cancelled or otherwise processed, and is also requesting availability at a time in the future (e.g., rather than retroactively). For illustrative purposes, it may be assumed that the search query received at step 305 is an active search.

At step 320, the crawler connect service host platform 104 may begin looping through the active searches. For example, with regard to the search query received at step 305, the crawler connect service host platform 104 may identify whether or not any of the availability information (e.g., tee times or other reservations) from the crawler systems are relevant to the search query (e.g., does the availability information match what was requested in terms of date and golf course, or whatever else was requested). If the crawler connect service host platform 104 identifies that no availability information is relevant, it might not proceed, and may instead await further information from the crawler systems. Otherwise, if the crawler connect service host platform 104 identifies that availability information is relevant, it may proceed to step 325.

At step 325, the crawler connect service host platform 104 may identify whether or not any of the availability information (e.g., tee times or other reservations) from the crawler systems match preference information (e.g., time range, course/venue, number of players/participants, or the like) specified in the search query. If there is no availability (e.g., tee times, reservations, bookings, or the like) that matches the preference information specified in the search query, the crawler connect service host platform 104 may set an availability flag on the search query to false. In doing so, the crawler connect service host platform 104 may indicate that there is no availability (e.g., tee times, bookings, reservations, or the like) matching the query request. If the crawler connect service host platform 104 does identify availability matching the query request, it may proceed to step 330.

At step 330, the crawler connect service host platform 104 may check further parameters corresponding to the availability information to identify how the availability flag should be set. For example, the crawler connect service host platform 104 may identify whether or not any identified tee times or other reservations are within a predetermined time window of a current time (e.g., fifteen minutes, or the like). If the crawler connect service host platform 104 identifies that all identified tee times, reservations, or the like are within the predetermined time window, it may set the availability flag to false. If the crawler connect service host platform 104 identifies that at least one identified tee time, reservation, or the like is outside of the predetermined time window, the crawler connect service host platform 104 may perform further parameter analysis with regard to the corresponding tee time, reservation, or the like.

For example, the crawler connect service host platform 104, the crawler connect service host platform 104 may identify whether or not the at least one identified tee time, reservation, or the like is different than the last tee time, reservation, or the like of which the user was previously notified. If the crawler connect service host platform 104 identifies that the at least one identified tee time, reservation, or the like is not different, the crawler connect service host platform 104 may leave the availability flag set to true. For example, the crawler connect service host platform 104 might not flip the availability flag from true to false because there is still a tee time, reservation, or the like that matches the search query. Rather, the crawler connect service host platform 104 may set the availability flag to false (e.g., flip the availability flag from true to false) when there are no tee times, reservations, or the like at all that match the preferences of the search query. In contrast, if the crawler connect service host platform 104 identifies that at least one identified tee time, reservation, or the like is different, the crawler connect service host platform 104 may perform further parameter analysis with regard to the corresponding tee time, reservation, or the like.

For example, the crawler connect service host platform 104 may identify whether or not the at least one identified tee time, reservation, or the like has existed for at least a threshold period of time (e.g., thirty minutes, or the like). If the crawler connect service host platform 104 identifies that the at least one identified tee time, reservation, or the like has not existed for at least the threshold period of time, it may set the availability flag to false. Otherwise, if the crawler connect service host platform 104 identifies that the at least one identified tee time, reservation, or the like has existed for at least the threshold period of time, and the other criteria described above are satisfied, the crawler connect service host platform 104 may set the availability flag to true (or, in instances where the availability flag is already set to true, the crawler connect service host platform 104 may leave the availability flag set to true). Although several parameter comparisons are described at step 330, other comparisons/analysis may be performed without departing from the scope of the disclosure.

At step 335, the crawler connect service host platform 104 and/or notification generation platform 105 may identify whether or not the availability flag was flipped from false to true based on the parameter comparison performed at step 330. If the crawler connect service host platform 104 and/or notification generation platform 105 identifies that the availability flag was flipped from false to true, the crawler connect service host platform 104 and/or notification generation platform 105 may proceed to step 340. Otherwise, if the crawler connect service host platform 104 and/or notification generation platform 105 identifies that the availability flag was not flipped from false to true (e.g., remained at true, flipped from true to false, or remained at false), the crawler connect service host platform 104 may return to step 310, where additional availability information may be collected for analysis. For example, if the availability flag remains true, there may still be a tee time and/or other reservation available that matches the search query, so an additional notification should not be sent (e.g., to minimize notifications sent to the user). For example, at any given time, if the availability flag remains true, if the user received a notification including a link to available tee times, reservations, or the like, they will already have observed this availability. Rather, by operating in this way, the crawler connect service host platform 104 and/or notification generation platform 105 may proceed to step 340 only where a time slot was not available, but now is available.

At step 340, the notification generation platform 105 may generate availability notifications based on the detection (at step 335) that the availability flag has flipped from false to true. In some instances, the notification generation platform 105 may generate multiple availability notifications for responding to the search query (e.g., for different courses, venues, courses/venues under common ownership, or the like). In some instances, the notification generation platform 105 may generate the availability notifications in response to the search query and/or other queries. Once generated, the notification generation platform 105 may gather all of the unsent notifications (e.g., at a predetermined interval such as thirty seconds, or the like), and bundle them to be sent to the appropriate users. By bundling these notifications accordingly (e.g., into common physical emails, texts, and/or other message formats), additional costs of sending separate notifications may be avoided.

After generating the availability notification(s), the notification generation platform 105 may send the availability notification(s) for display at the user device 106 accordingly. For example, the user device 106 may display a graphical user interface similar to graphical user interface 405, which is illustrated in FIG. 4.

Although a number of the above described steps are described as being performed by the crawler connect service host platform 104 and/or the notification generation platform 105, in some instances, these two platforms may be integrated into a common computing platform, and thus these steps may be performed by the common computing platform. Furthermore, although these steps are described primarily in the context of golf tee times, they may be applied to identify availability and generate/send notifications accordingly in any number of alternative contexts (e.g., dining or other reservations, flight or other bookings, and/or any other reservation/booking contexts) without departing from the scope of the disclosure.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive, from a user device, a search query, wherein the search query requests availability information corresponding to preference information;
receive, from a plurality of crawler systems, the availability information;
aggregate the availability information;
identify a subset of the availability information relevant to the search query;
perform a parameter comparison for the subset of the availability information, wherein performing the parameter comparison comprises, for all given information included in the subset of the availability information:
identifying whether or not the given information has a time value later than a predetermined time duration from a current time,
identifying whether or not a historical notification previously indicated the given information, and
identifying whether or not the given information has existed for more than a minimum duration of time;
based on detecting that the given information has the time value later than the predetermined time duration, the historical notification did not previously indicate the given information, and that the given information has existed for more than the minimum duration of time, activate an availability flag by changing the availability flag from false to true; and
based on detecting activation of the availability flag from false to true, send, to the user device, an availability notification indicating the given information.

2. The computing platform of claim 1, wherein the availability information comprises golf tee time information.

3. The computing platform of claim 1, wherein the preference information comprises one or more of: a golf course, a date, or a time range.

4. The computing platform of claim 1, wherein each of the plurality of crawler systems are configured to crawl a tee time availability system at a corresponding golf course.

5. The computing platform of claim 4, wherein the computing platform stores additional computer-readable instructions that, when executed by the at least one processor, further cause the computing platform to:
send one or more commands to each of the plurality of crawler systems directing the corresponding crawler system to execute the crawl during a specified time period, wherein sending the one or more commands to each of the plurality of crawler systems directing the corresponding crawler systems to execute the crawl during the specified time period causes each of the plurality of crawler systems to execute the crawl during the corresponding specified time period.

6. The computing platform of claim 5, wherein the specified time period corresponds to an amount of days that tee times, for a corresponding golf course, are available to be booked in advance.

7. The computing platform of claim 5, wherein the specified time period corresponds to a daily time range.

8. The computing platform of claim 5, wherein the one or more commands to each of the plurality of crawler systems directing the corresponding crawler systems to execute the crawl during the specified time period further cause each of the plurality of crawler systems to execute the crawl at a specified frequency.

9. The computing platform of claim 8, wherein the frequency is dynamically adjusted using an artificial intelligence (AI) model.

10. The computing platform of claim 9, further comprising training the AI model based on historical booking information comprising one or more of: season information, location information, longitude information, latitude information, weather information, days of a week, golf course information, or whether a golf course is public or private, and wherein training the AI model configures the AI model to output, for each of the plurality of crawler systems, one or more of: a frequency at which the crawl executes or a frequency distribution over which the crawl executes, wherein the frequency distribution indicates a plurality of frequencies and corresponding time ranges during which the crawl executes according to each of the plurality of frequencies.

11. The computing platform of claim 10, wherein the AI model is further trained, using a dynamic feedback loop, based on the frequency and the given information.

12. The computing platform of claim 9, wherein dynamically adjusting the frequency causes a first crawler system of the plurality of crawler systems to crawl at multiple different frequencies during a single day.

13. The computing platform of claim 9, wherein dynamically adjusting the frequency causes a first crawler system of the plurality of crawler systems to crawl according to a first frequency distribution during a first day and a second frequency distribution during a second day, wherein the first day and the second day occur within a week of each other.

14. The computing platform of claim 9, wherein dynamically adjusting the frequency causes a first crawler system of the plurality of crawler systems to crawl at a first frequency and a second crawler system of the plurality of crawler systems to crawl at a second frequency.

15. The computing platform of claim 1, wherein the computing platform stores additional computer-readable instructions that, when executed by the at least one processor, further cause the computing platform to:
store previously received availability information, wherein the previously received availability information was collected during a most recent previously conducted crawl, wherein identifying whether or not the given information has existed for more than a minimum duration of time comprises:
comparing the given information to the previously received availability information,
based on identifying that the given information is included in the previously received availability information, identifying that the given information has existed for at least the minimum duration of time, and
based on identifying that the given information is not included in the previously received availability information, identifying that the given information has not existed for more than the minimum duration of time.

16. The computing platform of claim 1, wherein the availability notification indicates that at least one tee time is available within a time range specified in the search query.

17. The computing platform of claim 1, wherein the availability notification includes a selectable user interface element corresponding to each tee time range indicated in the availability notification.

18. The computing platform of claim 17, wherein the computing platform stores additional computer-readable instructions that, when executed by the at least one processor, further cause the computing platform to:
based on receiving a user input corresponding to one of the selectable user interface elements, send one or more commands directing a booking system for a golf course of a particular tee time associated with the one of the selectable user interface elements to book the particular tee time, wherein sending the one or more commands directing the booking system for the golf course of the particular tee time associated with the one of the selectable user interface elements to book the particular tee time causes the booking system for the golf course of the particular tee time associated with the one of the selectable user interface elements to book the particular tee time.

19. A method comprising:
receiving, from a user device, a search query, wherein the search query requests availability information corresponding to preference information;
receiving, from a plurality of crawler systems, the availability information;
aggregating the availability information;
identifying a subset of the availability information relevant to the search query;
performing a parameter comparison for the subset of the availability information, wherein performing the parameter comparison comprises, for all given information included in the subset of the availability information:
identifying whether or not the given information has a time value later than a predetermined time duration from a current time,
identifying whether or not a historical notification previously indicated the given information, and
identifying whether or not the given information has existed for more than a minimum duration of time;
based on detecting that the given information has the time value later than the predetermined time duration, the historical notification did not previously indicate the given information, and that the given information has existed for more than the minimum duration of time, activating an availability flag by changing the availability flag from false to true; and
based on detecting activation of the availability flag from false to true, sending, to the user device, an availability notification indicating the given information.

20. A computing platform comprising:
at least one processor;
a communication interface communicatively coupled to the at least one processor; and
memory storing computer-readable instructions that, when executed by the at least one processor, cause the computing platform to:
receive, from a user device, a search query, wherein the search query requests golf tee time availability information corresponding to preferences specified in the search query;
receive, from a plurality of crawler systems, at least one golf tee time;
identify that the at least one golf tee time is relevant to the search query;
perform a parameter comparison for the at least one golf tee time, wherein performing the parameter comparison comprises:
identifying that the at least one golf tee time has a time value later than a predetermined time duration from a current time,
identifying that a historical notification indicating the at least one golf tee time has not been sent, and
identifying that the at least one golf tee time has existed for more than a minimum duration of time;
based on results of the parameter comparison, activate an availability flag by changing the availability flag from false to true; and
based on detecting activation of the availability flag from false to true, send, to the user device an availability notification indicating the at least one golf tee time.
